(19) United States
(12) Patent Application Publication
(10) Pub. No.: US 2026/0112513 A1
(43) Pub. Date: Apr. 23, 2026

(54) SYSTEMS AND METHODS FOR CLEANING CONTROL ROD DRIVES

(71) Applicant: GE-Hitachi Nuclear Energy Americas LLC, Wilmington, NC (US)

(72) Inventors: Daniel T. O'Leary, Charlotte, NC (US); John P. Moriarty, Hapstead, NC (US); Drew R. Holifield, Flint, MI (US); Brandon L. Smith, Watha, NC (US); Joseph V. Romano, Wilmington, NC (US)

(21) Appl. No.: 18/924,945

(22) Filed: Oct. 23, 2024

(51) Int. Cl. G21C 19/20

(52) U.S. Cl. CPC G21C 19/207

(57) ABSTRACT

Systems and methods use inserted dividers with control rod drives (CRDs) to flush CRDs from inside a reactor. Dividers separate flush zones from the reactor. Pumps, injectors, gravity, or any other drive, potentially in combination with draining pumps, vacuums, or other suctioning device, flow the fluid through the divider into the zone and back out of the same for flushing out radiation and debris or bringing about any other desired condition. A handling pole may extend several meters to allow operators to reach any CRD and place the divider and flushing components about the same. Flow paths may extend with the pole to deliver and remove the flush fluid to divider ports. Additional cameras, locators, detectors, batteries, etc. may be used to inspect and clean. The systems may clean CRDs whenever accessible, such as after a control blade or rod has been removed during a maintenance outage.

### BACKGROUND

FIG. 1 is a cross-section illustration of a related art control rod drive (CRD) 1 useable in a nuclear reactor. Similar related art CRDs are shown and described in U.S. Pat. No. 5,379,330 to Lovell et al., incorporated by reference herein in its entirety. As shown in FIG. 1, CRD 1 includes an inner cylinder 57 and an outer tube 56, which form an annulus through which water is applied to a collet piston 29b to unlock index tube 26. Collet housing 51, a part of outer tube 56 is provided with ports 73 to permit free passage of water from the clearance space between the outer diameter of index tube 26 and the inner diameter of inner cylinder 57 and the inner diameter of collet housing 51. The bottom of collet piston 29b may rest against spacer 52 in the upper portion of the annular space. Grooves in spacer 52 permit the passage of water between the bottom of the collet piston 29b and the passage area within the cylinder, tube and flange.

A locking mechanism for CRD 1 includes collet fingers 29a, collet piston 29b, barrel 35, guide cap 39, and collet spring 31. The mechanism is contained in collet housing 51 portion of outer tube 56 and locks index tube 26 to hold the control rod at a selected position. A collet assembly includes collet piston 29b fitted with four piston seal rings, two outer seal rings 28 and two inner seal rings 27, six fingers 29a and a retainer and is set into a bore in collet housing 51. In addition, collet spring 31, barrel 35 and guide cap 39 are installed in the collet housing 51.

Guide cap 39 is held in place above the collet by three plugs 37 that penetrate the upper end of collet housing 51; plugs 37 are held in place by fillister-head screws. Guide cap 39 provides a fixed camming surface to guide collet fingers 29a upward and away from index tube 26 when unlocking pressure is applied to collet piston 29b. Barrel 35 is installed below guide cap 39 and serves as fixed seat for collet spring 31.

The collet mechanism requires a hydraulic pressure greater than reactor pressure to unlock for CRD-withdraw movement. A preload is placed on collet spring 31 at assembly and must be overcome before the collet can be moved toward the unlocked position. For control rod withdrawal, a brief insert signal is applied to move index tube 26 upward to relieve the axial load on collet fingers 29a, camming them outward against the sloping lower surface of index tube locking notch 55. Immediately thereafter, withdraw pressure is applied. In addition to moving index tube 26 downward, this pressure is at the same time applied to the bottom of collet piston 29b to overcome the spring pressure and cam the fingers 29a outward against guide cap 39. When the withdraw signal ceases, the spring pressure forces the collet downward so that fingers 29a slip off guide cap 39. As index tube 26 settles downward, collet fingers 29a snap into the next higher notch and lock. When collet fingers 29a engage a locking notch 55, collet piston 29b transfers the control rod weight from index tube 26 to outer tube 56.

Unlocking is not required for CRD insertion. Collet fingers 29a are cammed out of the locking notch as index tube 26 moves upward. Fingers 29a grip the outside wall of index tube 26 and snap into the next lower locking notch for single-notch insertion to hold index tube 26 in position. For scram insertion, index tube 26 moves continuously to its limit of travel during which the fingers snap into and cam out of each locking notch as index tube 26 moves upward. When the insert, withdraw or scram pressures are removed, index tube 26 settles back, from the limit of travel, and locks to hold the control rod in the required position. Index tube 26 is a nitrided stainless-steel tube threaded internally at both ends. The spud 46 is threaded to its upper end, while the head of a drive piston is threaded to its lower end. Both connections are secured in place by means of bands 25 with tab locks.

Several notches 55 are machined into the wall of index tube 26, all but one of which are locking notches spaced at 6-inch intervals. Uppermost surfaces of notches 55 engage collet fingers 29a, providing increments at which a control rod may be positioned and preventing inadvertent withdrawal of the rod from the core. The lower surfaces of notches 55 slope gradually so that the collet fingers cam outward for control rod insertion.

When a control rod is driven upward to its fully inserted position during normal operation or scram, the upper end of the piston head contacts spring washers 30 which are installed below the stop piston 33. Washers 30 and stop piston 33 provide the upper limit of travel for the drive piston. Spring washers 30, together with the series of buffer orifices 53 in the upper portion of piston tube 15, effectively cushion the moving drive piston and reduce the shock of impact when the piston head contacts stop piston 33.

The piston tube assembly forms the innermost cylindrical wall of the CRD. It is a welded unit consisting of piston tube 15 and position indicator tube 61. The piston tube assembly provides three basic functions for CRD operation: (a) position indicator tube 61 is a pressure-containing part which forms a drywell housing for a position indicator probe; (b) piston tube 15 provides for the porting of water to or from the upper end of the piston head portion of the drive piston during rod movement; and (c) during control rod scram insertion, buffer orifices 53 in piston tube 15 progressively shut off water flow to provide gradual deceleration of the drive piston and index tube 26. Stud 59 is welded to the upper end of tube piston 15. Stud 59 is threaded for mounting the stop piston 33. A shoulder on the stud, just below the threaded section, is machined to provide a recess for the spring washers 30 that cushion the upward movement of the drive piston. The tube and head sections of piston tube 15 provide space for position indicator tube 61, which is welded to the inner diameter of the threaded end of head section of tube 15 and extends upward through the length of tube 15, terminating in a watertight cap near the upper end of the tube section.

Stop piston 33 threads onto the stud 59 at the upper end of piston tube 15. This piston provides the seal between reactor pressure and the area above the drive piston. It also functions as a positive-end stop at the upper limit of drive piston travel. Spring washers 30 below the stop piston help absorb the final mechanical shock at the end of travel. Seals 34 include an upper pair used to maintain pressure above the drive piston during CRD withdrawal and a lower pair used only during the cushioning of the drive piston at the upper end of the stroke. Two external bushings 32 prevent metal-to-metal contact between stop piston 33 and index tube 26.

As seen in FIG. 1, spud 46 connects the control rod and CRD and is threaded onto the upper end of index tube 26 and held in place by a locking band. Six spring fingers permit the spud to enter the mating socket on the control rod. A lock plug then enters the spud from the socket and prevents uncoupling. The control rod can be uncoupled by lifting the lock plug by raising an uncoupling rod assembly including control rod 48 and tube 43. Outer filter assembly 45 and inner filter assembly 41 are installed near the upper end of CRD 1. Both are provided to filter reactor water flowing into the CRD, removing foreign particles or abrasive matter that could result in internal damage and excessive wear.

Outer filter assembly 45 includes a ring with a flange on its outer periphery, a perforated cylinder for supporting a woven wire filter cloth, and a guide welded together. The outer filter is installed on the CRD by three lock-wired screws 40 that secure the lower end of outer filter 45 to guide cap 39. Outer filter assembly 45 removes foreign particles from reactor water entering the annulus between the CRD outer tube and a thermal sleeve in the reactor vessel CRD housing.

Inner filter assembly 41 includes a ring with a grooved flange on its outer periphery and an un-grooved flange on its inner periphery, a perforated cylinder for supporting a woven wire filter cloth, and a spring retainer assembly welded together. The inner filter prevents entry of particulate matter with reactor water entering the interior of the CRD through coupling spud 46. Center lug 44 at the top of stop piston 33 is provided for mounting inner filter assembly 41. Inner filter assembly 41 is held in place by spring clip 42 which grips lug 44. The outside of the ring at the top of the filter cylinder is hard-surfaced to reduce wear from contact with the inside wall of index tube 26 and is sealed against water leakage by means of seal ring 50 installed in the groove in the ring.

FIG. 2 is an illustration of a top portion of related art CRD 1 from FIG. 1, where the drive penetrates through pressure vessel 70 and connects to cruciform control rod 82 that may be moveable with CRD 1 to control the reactor. As seen in FIG. 2, control rod guide tube 80 may house a lower portion of control rod 82 in a generally cylindrical body that surrounds and guides vertical movement of control rod 82. Lower opening 81 of control rod guide tube may permit spud 46 to connect up to control rod 82 for movement with the drive. Thermal sleeve 85 may extend downward from opening 81 to connect to lower portions of the drive, including inner and outer filter assemblies 41 and 45.

During maintenance of CRD 1, following removal of outer filter assembly 45, uncoupling rod 82 and spud 46, inner filter assembly 41 is removed. This filter has been exposed to fields of radiation during reactor operation. Long-handled tongs or grippers have been used to handle the inner filter. For example, a handle may be operated to retract a shaft relative to a stationary support. An expandable element has one end secured to the shaft and the other end secured to the support. Upon retraction of the shaft, the expandable component is compressed and expanded to the extent that its outer periphery engages and thereby captures the inner filter. Inner filter assembly 41 is then slid out by pulling out the gripper tool.

This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments include systems that may be assembled and moved into or about nuclear control rod drives (CRD) to clean the same of radioactive and debris contamination. Example embodiment assemblies are shaped to move near an opening of the CRD from inside the reactor, such as with a plate that fits into a guide tube above and opening into the CRD and separates a flushing zone within the CRD for cleaning with a flush fluid. A drive, such as a pump, injector, gravity-driven line, etc. may connect to a fluid port passing through the plate to push the fluid through the plate into the zone for open path cleaning, or flushing. The flush fluid may pass over CRD components and internals in the zone, picking up or dissolving debris, radioactive particles, and deposits, or otherwise conditioning the CRD favorably. Another port can receive the flush fluid carrying these materials from the same and drain the same to a reservoir. A draining pump or vacuum or other suction device may be combined with the reservoir to provide active suction and removal of the flush fluid. The separating plate can be positioned by any handling structure, including a handling pole that extends a significant distance to reach the guide tube or CRD. The handling pole, along with any tubing or other flow paths to provide and drain the flush fluid, and any wires for controls, may be operated and accessed from outside the reactor, such as by operators performing maintenance around the open reactor. Additional components, such as cameras, position indicators, local power, etc. may be joined to the pole, to enhance operations and ensure the assembly moves together.

Example methods clean CRDs with the flushing fluid by inserting the assembly around the CRD when it is accessible, such as into a control rod guide tube after a control blade or rod has been removed. The plate of the assembly could be placed anywhere near the CRD, such as in a control rod guide tube and/or opening of the same into the CRD above an inner filter assembly, during plant maintenance when the control blade is decoupled. Operators may then inject and suction the flush fluid across the plate to flush the CRD internals without needing to access an underside of the reactor for the CRD or its drive mechanism, or to otherwise try to reach CRDs through the reactor with other cleaning mechanisms. The handling pole may be used to move the plate from CRD to CRD for cleaning, which reduces radioactivity of and debris in the CRDs.

### BRIEF DESCRIPTIONS OF THE DRAWINGS

Example embodiments will become more apparent by describing, in detail, the attached drawings, wherein similar elements are represented by similar reference numerals. The drawings serve purposes of illustration only and thus do not limit example embodiments herein.

Elements in these drawings may be to scale with one another and exactly depict shapes, positions, operations, and/or wording of example embodiments, or some or all elements may be out of scale or embellished to show alternative proportions and details.

FIG. 1 is a cross-section illustration of a related art nuclear reactor control rod drive.

FIG. 2 is a perspective view of a top portion of the related art nuclear reactor control rod drive of FIG. 1.

FIG. 3 is a perspective illustration of an example embodiment flushing assembly.

FIG. 4A is a side profile of the example embodiment flushing assembly.

FIG. 4B is a front profile of the example embodiment flushing assembly as installed in a reactor.

FIG. 5 is a perspective illustration of the example embodiment flushing assembly installed in a control rod guide tube.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion.

In listing items in example embodiments, conjunctions and inclusive terms like “and,” “with,” and “or” include all combinations of one or more of the listed items without exclusion of non-listed items. The use of “etc.” is defined as “et cetera” and indicates the inclusion of all other elements belonging to the same group of the preceding items, in any “and/or” combination(s). Modifiers “first,” “second,” “another,” etc. do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,”“adjacent”versus “directly adjacent,”etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term.

Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

Proportions, sizes, and shapes shown in the figures are examples for illustration. While they reflect features of some example embodiments, other relationships and magnitudes of dimensions are included in these examples. As used herein, “azimuthal” and “angular” directions substantially follow a rounded perimeter of a referenced feature, and “radial” directions substantially follow a radius of that rounded perimeter, perpendicular to the angular direction. “Vertical” and height directions substantially follow an up-down orientation, orthogonal to the radial and angular directions of a referenced feature. “Length” and “width” are substantially perpendicular dimensions of a referenced feature, with “length” generally being the longest dimension of the feature.

The inventors have recognized a need for reducing radioactivity and radiation dosage from control rod drives, as well as removing other contaminating materials from the same. Typical approaches may increase shielding around control rod drives and limit personnel time and proximity to the same while they manually work on the drives; however, this does not allow efficient and effective working conditions and interaction with the drives nor quickly maintain the same, which may be crucial during a maintenance outage where a plant is inoperable. It is further difficult to circulate reactor coolant through control rod drives at a bottom of the reactor, and this anyway risks migrating contamination and debris from the drives into the reactor. To overcome these newly-recognized problems as well as others, the inventors have developed example embodiments and methods described below to address these and other problems recognized by the inventors with unique solutions enabled by example embodiments.

The present invention is systems and methods for flushing control rod drives. In contrast to the present invention, the few example embodiments and example methods discussed below illustrate just a subset of the variety of different configurations that can be used as and/or in connection with the present invention.

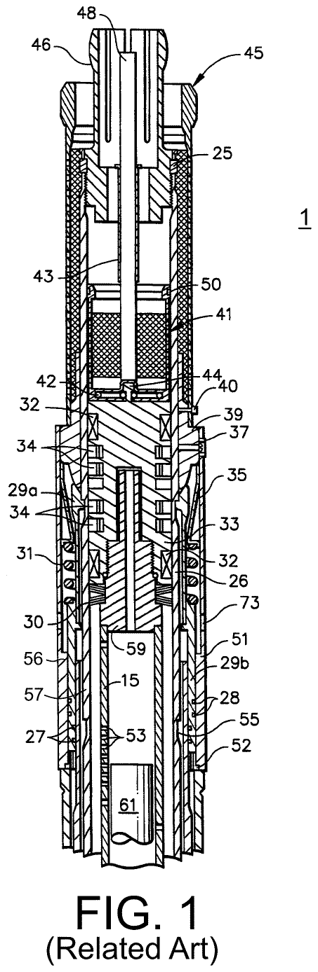

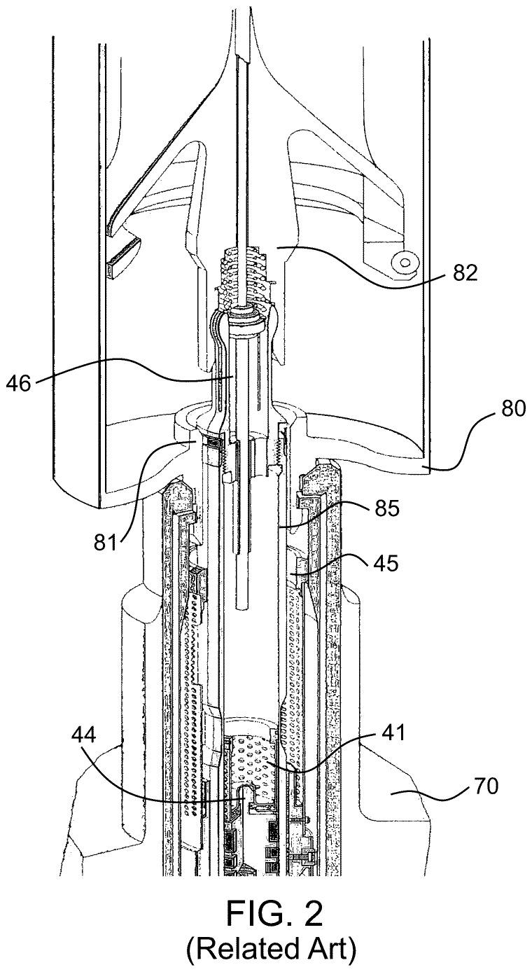

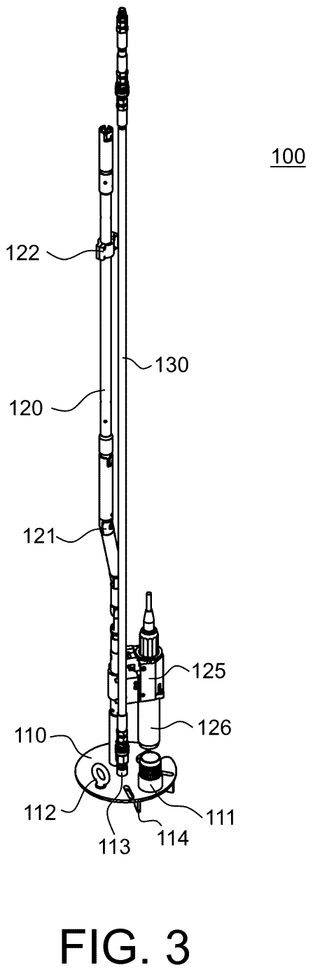

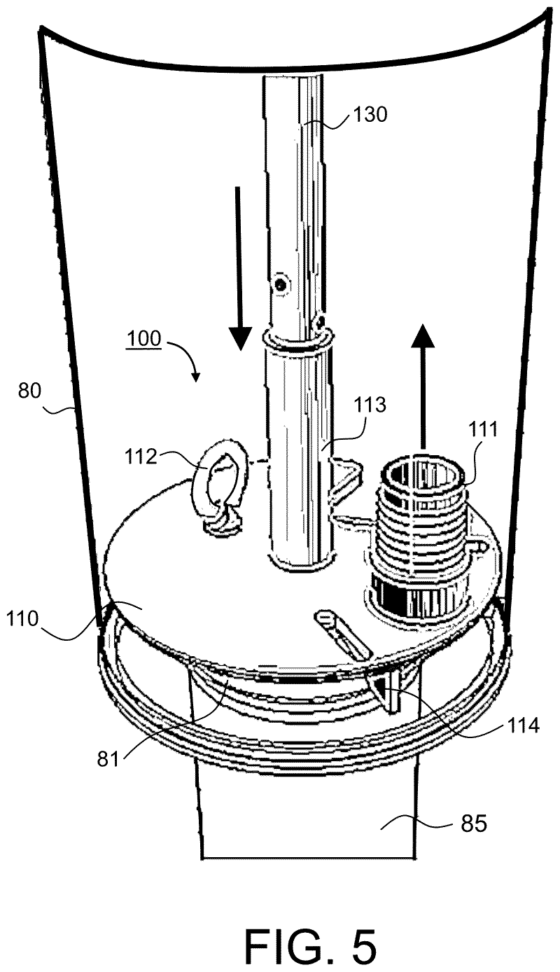

FIG. 3 is an illustration of an example embodiment flush assembly 100 useable with a nuclear control rod drive (CRD), such as related art CRD 1 of FIGS. 1 and 2. Assembly 100 is shaped and sized to fit within a CRD guide tube from an opening inside the reactor with the control element removed. For example, assembly 100 may fit within control rod guide tube 80 (FIG. 2) in a radial direction while extending vertically downward to a bottom of guide tube 80 at opening 81. This positioning may provide access to the CRD inner filter assembly 41 (FIG. 2) inside an upper portion of index tube 26 (FIG. 1) through opening 81 of guide tube 80. This positioning is shown again in FIG. 5, with assembly 100 lowered into guide tube 80 and approaching a bottom where opening 81 provides passage to thermal sleeve 85 and thus the filter assembly below. Although assembly 100 is shaped to fit within guide tube 80, other heights and positions for operation of assembly 100 are useable to clean and flush desired locations.

As shown in FIG. 3, example embodiment assembly 100 includes isolation plate 110 shaped to divide or occlude, at least partially, a flush volume below plate 110. For example, plate 110 may be substantially flat and circular, with radial dimensions matching an inner radius of a guide tube or other CRD void. The edge of plate 110 may thus form a loose seal with the guide tube or void, allowing assembly movement but lesser fluid flow between assembly 100 and surface defining the void. Cut-outs and other shapes may be used to avoid CRD and reactor structures or other intervening elements that permit plate 110 to be inserted into the guide tube. Plate 110 may further include separator 114, such as legs or extensions at a bottom of plate 110, to provide positioning, clearance, and cleaning space. For example, as shown in FIG. 5, separator 114 may be sized and shaped to fit about opening 81 above thermal sleeve 85, providing spacing from a bottom of guide tube 80.

As shown in FIG. 3, plate 110 includes ports for introducing and removing a flushing flow of fluid cleaner across plate 110. For example, plate 110 may include intake port 113 to receive a fluid flow, and plate 110 may include an outlet port 111 to remove the fluid flow. In this way a flushing fluid flow may be circulated partially or entirely below plate 110 for removing contamination or other materials in a space below plate 110, such as in a guide tube and/or CRD upper space. For example, pressurized, deionized water may be introduced through intake port 113 to a space below plate 110, and the water with any contaminants or cleaning targets carried or dissolved therein my be removed by a vacuum through outlet port 111. Any other cleaning fluids and compositions may similarly be introduced and removed through ports 111 and 113 to create a cleaning flow below plate 110. Although a single, central intake port 113 is shown with an offset outlet port 111, any number and positioning of ports 111 and 113 are possible to generate the cleaning flow under plate 110. Similarly, sizing and number of ports 111 and 113 can be adjusted based on fluid flow characteristics and desired flush volume.

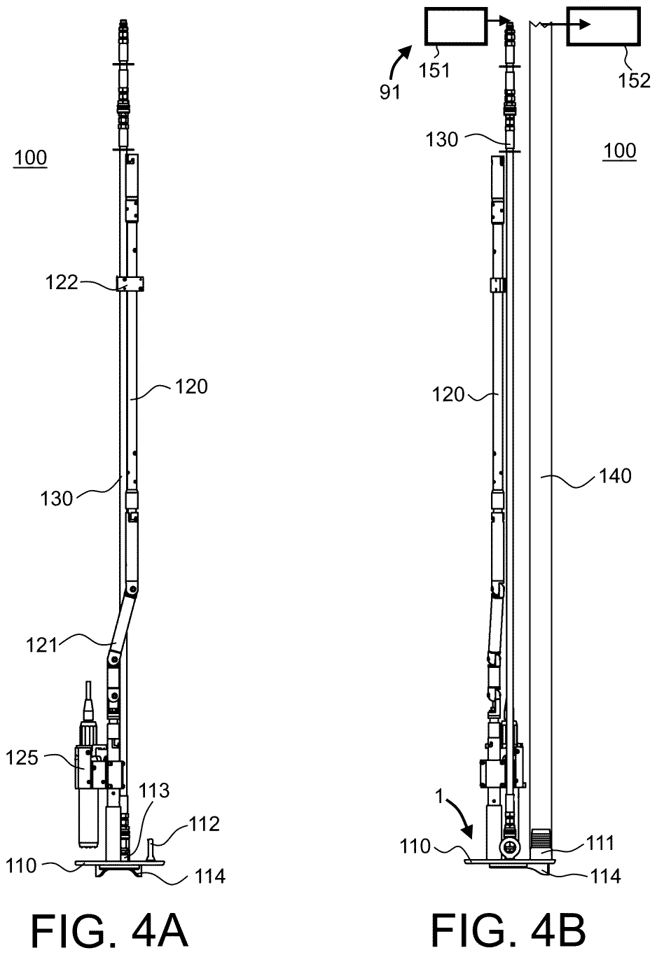

The flush fluid may be provided to intake port 113 by a drive for injecting the fluid through plate 110 and port 113. For example, supply line 130 may run in any direction from intake port 113 to the drive to connect the flush fluid. As shown in FIGS. 4A and 4B, supply line 130 may be a flexible hose or other tubing running from plate 110 up a vertical height of a reactor, or any other height of a fluid reservoir for flushing. Staging area 91 may have flush supply 151, which may be a pump or a gravity-driven reservoir of the flushing fluid acting as the drive. Similarly, the flush fluid may be removed from outlet port 111 by relief line 140 running vertically upward from outlet port 111. Relief line 140 may extend in any direction out of a reactor to a staging area with contaminated flush reservoir 152 for receiving the flush fluid exiting the flow below plate 110. For example, flush reservoir 152 may collect the fluid by gravity or through suction or vacuum, in which case reservoir 152 may be part of a pump and relief line 140 may be more rigid to carry a negative or suction relative pressure without collapsing.

Example embodiment flush assembly may connect to and be operated from staging area 91 around the reactor, such as at an operator platform or crane at or above an opened reactor flange. Lines 130 and 140 may connect to ports 113 and 111 in any desired and secured manner, such as through matching threads, permanent welding, augur/tang connections, etc. to removably or permanently secure to and provide a flow path through plate 110 for flushing. Although lines 130 and 140 may run significant vertical distances, such as from a bottom of a reactor where CRDs 1 (FIGS. 1 and 2) are located submerged in reactor coolant all the way up to a head or flange of the same where staging area 91 is located in open air, it is also possible to omit or use much shorter lines 130 and 140, such as when a flush fluid is local to or within assembly 100.

As shown in FIGS. 3-4B, example embodiment flush assembly 100 may include handling pole 120 that may extend vertically, potentially in association or parallel with lines 130 and 140. Handling pole 120 may be an arm allowing an operator or crane or other structure to which it attaches install, manipulate, and/or remove assembly 100. For example, handling pole 120 may be telescoping, unfolding, a series of poles screwed or otherwise incrementally joining together, or otherwise have length to extend an entire depth from a reactor flange or staging area to a CRD for cleaning. In such an example, pole 120 may be several meters long or even over 10 meters long to so position plate 110 in a guide tube for the CRD from an operator position above a reactor in staging area 91. Pole 120 may include one or more wrists 121 that allow transverse offsetting and snaking of pole 120 to desired positions. Extension, movement, and reshaping of pole 120, potentially through wrists 121, by be executed by operators at an end of pole 120 or under power such as motors and controls driving pole 120.

Handling pole 120 may connect to plate 110 in a removable or non-removable manner to secure to plate 110 and ensure its positioning matches the manipulation of pole 120. Pole 120 may include several or single clip 122 keeping supply line 130 spaced from and secured to pole 120 during any number of movements or manipulations of plate 110 and assembly 100, and a similar clip may be used with relief line 140 (FIG. 4B) to keep all lines and connections to plate 110 together. Plate 110 may further include hook or eyelet 112 to allow connection to and manipulation of plate 110 manually or through other structures. For example, if pole 120 becomes unattached from plate 110 or inoperable, plate 110 may be retrieved by attaching a line to eyelet 112. In this way, operators may position and operate example embodiment flush assemblies potentially deep within the nuclear reactor while remaining substantially distanced from the CRDs and guide tubes, potentially outside the reactor in staging area 91.

Any other inspection and maintenance structure may be provided by handling pole 120. For example, camera 126 may be held with handling pole 120 through camera extension 125. Camera 126 may be battery-powered and provide wireless functionality to inspect surrounding materials, or camera 126 may have its own power and control line(s) running to it from a staging area along pole 120. For example, camera 126 may be pointed to an opening or slit in plate 110 to obtain imagery or video of a flush area. Any other component may be similarly attached as camera 126 or otherwise positioned with pole 120, including local power or power cables, control devices such as processors and wireless transceivers, monitors including radiation, chemistry, and positioning sensors, water sampling devices, tooling, etc. In this way, assembly 100 may provide several different functionalities, such as CRD flushing and monitoring of local radioactivity levels, that may otherwise require several different apparatuses and operations.

Example embodiment assemblies may be fabricated of resilient materials that are compatible with a nuclear reactor environment without substantially changing in physical properties, such as becoming substantially radioactive, melting, embrittling, and/or retaining/adsorbing radioactive particulates. For example, several known structural materials, including austenitic stainless steels 304 or 316, XM-19, zirconium alloys, nickel alloys, Alloy 600, non-soluble high density plastics etc. may be chosen for any element of components of example embodiment assemblies. Direct connections between distinct parts and all other direct contact points may be lubricated, insulated, coated, and/or fabricated of alternating or otherwise compatible materials to prevent seizing, fouling, metal-on-metal reactions, fretting, etc.

FIG. 5 is a perspective illustration showing an interior of control rod guide tube 80 having an example embodiment flush assembly 100 installed in the same for circulating a cleaning fluid in the guide tube and/or CRD connecting below. Example methods may install plate 110 at any desired time, such as when the control blade has been removed and/or guide tube 80 is otherwise accessible. This may be when CRD 1 is accessible from a top of a reactor flange, core, or other internal above CRD 1, such as during a maintenance outage, during plant or CRD manufacture, or decommissioning. Example embodiment flush assembly 100 may be installed through a vertical top of guide tube 80, due to its size and shaping to fit within any CRD opening, including that of guide tube 80 above the CRD. Handling pole 120 (FIGS. 3-4B) may position plate 110 at any desired vertical level and transverse positioning, with desired flush spacing below plate 110.

Operators may then drive the flush fluid through ports 113 and 111 to circulate a flushing flow through the guide tube and/or CRD. When used above opening 81 in guide tube 80, the flush may reach well into openings of the CRD, such as inner filter assembly 41 (FIGS. 1-2). For example, in FIG. 4B, a pressurized liquid may be driven by gravity and/or a pump from flush supply 151 above the CRD, down supply line 130 through port 113, and then suctioned in equal or similar volumes out through port 111, up through relief line 140 to flush reservoir 152, to pick up contaminants and other flush targets below plate 110. The amount of flush fluid injected in port 113 and suctioned from port 111 may be substantially equivalent, with flooded reactor depth and any perforations in plate 110 aiding the drive pressure to ensure volumetric balance through the cleaned space. Similarly, additional or lesser flush fluid may be injected versus suctioned, such that additional fluid may be drawn from or injected into the area near plate 110. In the instance where reactor coolant or a compatible fluid is used as the flush fluid, any escape of excess fluid from below plate 110 or bleed of reactor coolant into the space from above plate 110 may be inconsequential.

Camera 126 or other tooling may be used to inspect or otherwise interact with the flush area during this time, ensuring cleaning operations have been completed before assembly 100 is withdrawn or moved to another area, such as a different CRD. This may include use of a radiation sensor and/or chemical monitor to determine when local activity within the guide tube or CRD upper portions have been reduced. In this way, the volume separated or segmented by plate 110 may be flushed throughout its the entire volume below plate 110, such as in a guide tube and CRD connecting thereto.

In the example of a Boiling Water Reactor CRD cleaned by example embodiment flush assembly 100, radioactive contamination of the CRD was significantly reduced. Human operators around and below a reactor vessel typically must interact closely with instrumentation and CRD components at a bottom of a BWR, and an example embodiment flush assembly operated in accordance with example methods above was found to reduce human dosage to such workers by over 90% in terms of REM/hour. In this way example embodiment flush assembly 100 removes radioactive components, contaminants, and soluble compositions by flushing the CRD with the flush fluid when installed.

Some example embodiments and methods thus being described, it will be appreciated by one skilled in the art that examples may be varied through routine experimentation and without further inventive activity. For example, although some assemblies with disk-shaped plates are shown in some CRD openings, it is understood that any other shapes and sizes are useable with example embodiments and methods. Variations are not to be regarded as departure from the spirit and scope of the example embodiments, and all such modifications as would be obvious to one skilled in the art are intended to be included within the scope of the following claims. The claims below are not intended to be construed under 35 U.S.C. § 112(f) unless explicit means-plus-function language “means for” and “step for” are recited therein.

1. An assembly for use with a nuclear control rod drive (CRD) having an opening through which the CRD is open to a nuclear reactor pressure vessel internal, the assembly comprising:
a plate shaped to fit about the opening and create a separated volume for flushing inside the opening; and
a drive connected to a fluid port of the plate and configured to drive a flush fluid through the plate into the volume through the fluid port to flush the volume with the flush fluid.

2. The assembly of claim 1, further comprising:
a reservoir connected to a relief port of the plate and configured to collect the flush fluid from the volume.

3. The assembly of claim 2, wherein the reservoir is a pump configured to suction the flush fluid from the volume.

4. The assembly of claim 3, wherein the drive and the pump are configured to inject and suction substantially equal volumes of the flush fluid through the volume.

5. The assembly of claim 1, further comprising:
a handling pole connected to the plate and extending over 1 meter vertically from the plate; and
a supply line running from the drive to the port.

6. The assembly of claim 5, wherein the handling pole and the supply line extend from a guide tube having the opening into the CRD to a staging area around the reactor.

7. The assembly of claim 5, further comprising:
a relief line connected to a relief port of the plate; and
a reservoir connected to the relief line and configured to collect the flush fluid from the volume.

8. The assembly of claim 7, wherein the reservoir is a pump configured to suction the flush fluid from the volume through the relief line.

9. The assembly of claim 7, wherein the relief line and the supply line extend along the handling pole, and wherein the reservoir and drive are in a staging area around the reactor.

10. The assembly of claim 5, wherein the handling pole further includes a camera aligned with a perforation in the plate and configured to capture imagery of the volume.

11. The assembly of claim 5, wherein the handling pole includes an elbow configured to offset the plate in a transverse direction perpendicular to a length of the handling pole.

12. The assembly of claim 1, wherein the plate is a flat cylindrical disc and includes at least one separator extending vertically downward vertically about a cylindrical axis of the plate on an opposite side of the plate from the fluid port.

13. A nuclear reactor cleaning system comprising:
a control rod drive guide tube having a lower opening connecting to an internal space of a control rod drive that is in fluid communication with a nuclear reactor pressure vessel internal; and
a plate in the control rod guide tube, wherein the plate separates a volume for flushing inside the CRD from a space in the control rod guide tube, wherein the plate includes at least one port for injecting a flush fluid into the volume.

14. The system of claim 13, wherein the volume is inside an inner filter assembly of the CRD, and wherein the plate has an outer perimeter shaped to substantially match an inner perimeter of the control rod guide tube.

15. The system of claim 13, wherein the plate includes a fluid port for introducing the flush fluid into the volume and a relief port for removing the flush fluid from the volume after flushing the volume.

16. The system of claim 13, further comprising:
a drive connected to the port of the plate and configured to drive the flush fluid through the plate into the volume through the port to flush the volume with the flush fluid; and
a reservoir connected to a relief port of the plate and configured to collect the flush fluid from the volume, wherein the reservoir is a pump configured to suction the flush fluid from the volume.

17. The assembly of claim 16, further comprising:
a handling pole connected to the plate and extending over 1 meter vertically from the plate; and
a supply line running from the drive to the port.

18. A method of cleaning a nuclear reactor control rod drive (CRD), the method comprising:
removing a control element connected to the CRD to clear an opening through which the CRD opens to a nuclear reactor; and
positioning a plate from a space internal to a reactor pressure vessel to a space about the opening so as to create a separate volume for flushing inside the CRD, wherein the plate includes at least one port for injecting a flush fluid into the volume.

19. The method of claim 18, further comprising:
driving a flushing fluid into the separate volume through the plate; and
suctioning the flushing fluid through the plate after the flushing fluid has circulated within the separate volume and collected contamination from inside the volume.

20. The method of claim 19, wherein the driving is provided by a drive in a staging area outside the reactor pressure vessel, and wherein the suctioning is provided by a reservoir in the staging area.
